(19) United States
(12) Patent Application Publication
(10) Pub. No.: US 2026/0100818 A1
(43) Pub. Date: Apr. 9, 2026

(54) CONTROL UNIT FOR SUPPORTING ROLLBACK OF EEPROM DATA AND A CONTROL METHOD THEREFOR

(71) Applicant: HYUNDAI AUTOEVER CORP., Seoul (KR)

(72) Inventor: Min Ho Ahn, Seoul (KR)

(73) Assignee: HYUNDAI AUTOEVER CORP., Seoul (KR)

(21) Appl. No.: 19/339,035

(22) Filed: Sep. 24, 2025

(30) Foreign Application Priority Data
Oct. 4, 2024 (KR) 10-2024-0134563

(51) Int. Cl. H04L 9/08

(52) U.S. Cl. CPC H04L 9/0819; H04L 9/0869

(57) ABSTRACT

A control unit includes at least one electrically erasable programmable read-only memory (EEPROM) configured to store data. The control unit also includes a standby random access memory (RAM) configured to store encrypted data that encrypts a value corresponding to the data with a roll-back key. The control unit additionally includes a control circuit configured to decrypt the encrypted data with the roll-back key to generate decrypted data and roll back the data using the decrypted data.

### CROSS REFERENCE TO RELATED APPLICATION

This application claims the benefit of and priority to Korea Patent Application No. 10-2024-0134563, filed on Oct. 4, 2024, the entire contents of which are hereby incorporated herein by reference.

### FIELD OF TECHNOLOGY

The present disclosure relates to a technique for supporting rollback of EEPROM data.

### BACKGROUND

The statements in this section merely provide background information related to the present disclosure and may not constitute prior art.

A microcontroller unit (MCU) mounted on an electronic control unit (ECU) of a vehicle plays a vital role in running and managing various electronic control systems of the vehicle. The MCU may use several MCUs to control several systems including an engine, transmission, brake, steering, and safety system of a vehicle.

The MCU mounted on the ECU may precisely control fuel injection, ignition timing, and air-to-fuel ratio of an engine. For example, the performance of an engine may be maximized by properly injecting fuel, precisely timing ignition, and maintaining the optimum air-to-fuel ratio for efficient engine operation. This control also plays a vital role in reducing fuel consumption and minimizing exhaust emissions.

In addition, the MCU controls the shifting time point and shifting pattern of an automatic transmission to enable smooth and efficient shifting. This allows a driver to have a more comfortable and stable driving experience, and also improves the durability of the transmission. The shifting time point and pattern are adjusted in real time according to the driving situation, allowing optimal performance in various driving conditions.

The braking system and vehicle stability control system are also managed in real time through the MCU. The MCU controls the brake pressure during braking and prevents the wheels from locking through systems such as an anti-lock braking system (ABS). In addition, the MCU monitors and controls the movement of a vehicle through systems such as electronic stability control (ESC) to maintain the stability of the vehicle. This control plays a vital role in improving driving safety and preventing accidents.

The MCU collects data from various sensors, processes the data in real time, and plays a vital role in maintaining the optimal vehicle state. For example, the MCU may process data collected from oxygen sensors, temperature sensors, and speed sensors to improve engine efficiency and vehicle driving stability. In addition, the MCU may exchange data with other ECUs and systems in a vehicle using communication protocols such as a controller area network (CAN) and a local interconnect network (LIN). This communication function helps various systems in the vehicle to operate organically. Thus, data is exchanged in real time between various parts and systems of the vehicle and necessary control commands are transmitted.

The MCU may also detect abnormal states of a vehicle and may store diagnostic codes through an on-board diagnostics (OBD) system. This allows the diagnostic codes to be referenced during vehicle maintenance to quickly address an issue. The OBD system monitors various sensors and systems inside the vehicle, and records and notifies a driver and a mechanic when an abnormality occurs. This diagnostic function plays a vital role in facilitating vehicle maintenance and preventing potential issues in advance.

The MCU may perform various functions, including a central processing unit (CPU), a memory, I/O ports, an analog-to-digital converter (ADC), a timer/counter, and a communication module. The CPU may execute instructions and perform control logic, and the I/O ports may provide interfaces with sensors, actuators, and other ECUs. The ADC converts analog sensor data into digital signals for processing, and the timer/counter may be used for time-based control.

The memory of the MCU may include a read only memory (ROM), a random access memory (RAM), and an electrically erasable programmable read only memory (EEPROM). The ROM is nonvolatile memory, and data does not disappear even when power is turned off. The ROM mainly records programs during manufacturing, stores the operating software and control programs of the ECU, and includes initialization codes that are executed when a system boots. The RAM is volatile memory, and data may disappear when power is turned off. The RAM may stores data that the MCU processes in real time, store temporary data related to function calls, and temporarily store data when data is transferred.

The EEPROM is nonvolatile memory, and data does not disappear even when power is turned off. In addition, the EEPROM may be electrically erased and written, so data may be erased and rewritten in specific block units. The EEPROM may store vehicle setting values, store diagnostic codes and vehicle state information collected through a system, and store various event logs and history data. This data plays a vital role in monitoring the long-term state of a vehicle and, when necessary, analyzing the data to address issues.

### SUMMARY

An aspect of the present disclosure provides a technique for supporting rollback of EEPROM data. Another aspect of the present disclosure provides a technique for replicating EEPROM data.

According to an embodiment, a control unit is provided. The control unit includes at least one electrically erasable programmable read-only memory (EEPROM) configured to store data. The control unit also includes a standby random access memory (RAM) configured to store encrypted data that encrypts a value corresponding to the data with a roll-back key. The control unit additionally includes a control circuit configured to decrypt the encrypted data with the roll-back key to generate decrypted data and roll back the data using the decrypted data.

The EEPROM may include a plurality of blocks. Each block may be divided into a data area and a metadata area. The control circuit may be configured to store the data in the data area and store the roll-back key in the metadata area.

The metadata area of a block may include an identifier stored for identifying the block or the metadata area.

The control circuit mat be configured to store a random value in the data area, encrypt the random value to generate an encrypted random value, and store the encrypted random value in the standby RAM.

The control circuit may be configured to perform an XOR operation between the value corresponding to the data and the roll-back key to generate the encrypted data.

The control circuit may be configured to perform an XOR operation between the encrypted data and the roll-back key to generate the decrypted data.

The control unit may include a plurality of EEPROMs. The control circuit may be configured to store the encrypted data separately for each EEPROM in the standby RAM.

The data may include vehicle state information or vehicle failure information.

The control unit may further include a static RAM (SRAM) in which stored values are volatile when power supply to the control circuit is cut off. The standby RAM may be configured to maintain the encrypted data while the power supply to the control circuit is cut off.

The control circuit may be configured to store new data sequentially in a block in which data is not stored among the plurality of blocks. The control circuit may also be configured to, when data is stored in all blocks, sequentially reuse the blocks in order from a block in which data was first stored among the plurality of blocks.

According to another embodiment, a control method for supporting rollback of EEPROM data is provided. The control method includes storing data in at least one electrically erasable programmable read-only memory (EEPROM). The control method also includes encrypting a value corresponding to the data with a roll-back key to generate encrypted data. The control method additionally includes storing the encrypted data in a standby random access memory (RAM). The control method further includes decrypting the encrypted data with the roll-back key to generate decrypted data; and rolling back the data using the decrypted data.

The EEPROM may include a plurality of blocks. Each block may be divided into a data area and a metadata area. Storing the data in the EEPROM may include storing the data in the data area. Generating the encrypted data may include generating the encrypted data using the roll-back key stored in the metadata area.

The metadata of a block may include an identifier stored for identifying the block or the metadata area.

The EEPROM may have a plurality of roll-back keys stored for each block. The control method may further include finalizing the roll-back key for decryption according to the identifier before generating the decrypted data.

Storing the data in the EEPROM may further include storing a random value in the data area. Generating the encrypted data may include encrypting the random value with the roll-back key.

Rolling back the data may include comparing the decrypted data with the random values stored in the plurality of blocks to find a matching block that matches the decrypted data, and determining the data of the matching block as the data to be rolled back.

Generation the encrypted data may include generating the encrypted data by performing an XOR operation on the value corresponding to the data with the roll-back key.

Generation the decrypted data may include generating the decrypted data by performing an XOR operation on the encrypted data with the roll-back key.

The data may include vehicle state information or vehicle failure information.

The control method may further include storing temporary data in a static RAM (SRAM), wherein values stored in the SRAM may be volatile when power supply to a device controlling the EEPROM is cut off, and the standby RAM may be configured to maintain the encrypted data while the power supply to the device controlling the EEPROM is cut off.

Embodiments of the present disclosure may support the rollback of the EEPROM data and may replicate the EEPROM data.

### BRIEF DESCRIPTION OF THE DRAWINGS

In order for one having ordinary skill in the art to understand the present disclosure, various forms of the present disclosure are described by way of example with reference to the accompanying drawings, in which:

FIG. 1 is a configuration diagram illustrating a control unit according to an embodiment.

FIG. 2 is a block configuration diagram illustrating an EEPROM according to an embodiment.

FIG. 3 is a block configuration diagram illustrating a RAM according to an embodiment.

FIG. 4 is a part configuration diagram illustrating a data block according to an embodiment.

FIG. 5 is a part configuration diagram illustrating a metadata block according to an embodiment.

FIG. 6 is a part configuration diagram illustrating an encrypted data block according to an embodiment.

FIG. 7 is a diagram illustrating a process of a control unit encrypting and decrypting a random value according to an embodiment.

FIG. 8 is a diagram illustrating a process of a control unit rolling back data according to an embodiment.

FIG. 9 is a flowchart of a control method in which a control unit supports rollback of EEPROM data according to an embodiment.

### DETAILED DESCRIPTION

Hereinafter, embodiments of the present disclosure are described in detail with reference to accompanying drawings. It should be noted that in assigning reference numerals to respective elements in the drawings, the same reference numerals designate the same elements even when the elements are shown in different drawings. Furthermore, in describing the present disclosure, where it was determined that a detailed description of related known functions and constructions would obscure the gist of the present disclosure, the detailed description thereof has been omitted.

Furthermore, in describing the elements of the present disclosure, terms, such as the first, second, A, B, a, and b, may be used. However, the terms are used to merely distinguish one element from the other element. The essence, order, and sequence of the elements are not limited by these terms. Furthermore, in the case in which one element is described to be “connected”, “coupled,” or “jointed” to another element, the element may be directly connected or coupled to the other element, but it should be understood that a third element may be “connected”, “coupled,” or “jointed” between the two elements.

When a component, controller, control circuit, device, element, apparatus, unit, or the like of the present disclosure is described as having a purpose or performing an operation, function, or the like, the component, controller, control circuit, device, element, apparatus, unit or the like should be considered herein as being “configured to” meet that purpose or to perform that operation or function. Each component, controller, control circuit, device, element, apparatus, unit, and the like may separately embody or be included with a processor and a memory, such as a non-transitory computer readable media, as part of the apparatus.

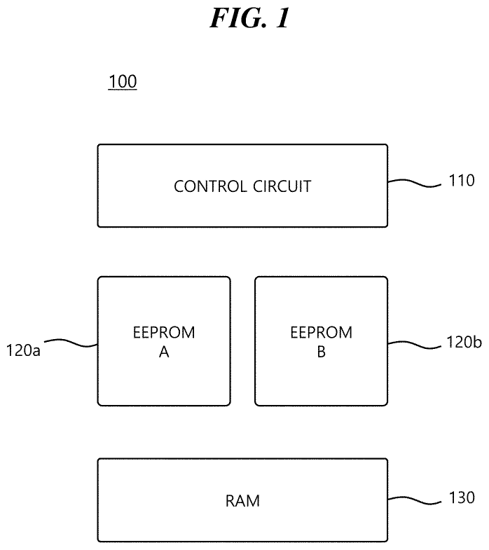

FIG. 1 is a configuration diagram illustrating a control unit according to an embodiment.

Referring to FIG. 1, a control unit 100 may include a control circuit 110, an EEPROM 120a, 120b, and a RAM 130.

The control unit 100 may be an MCU. In an embodiment, in addition to the aforementioned configurations, the control unit 100 may further include a CPU, a ROM, I/O ports, an ADC, a timer/counter, and a communication module.

The control circuit 110 may generally control operation of the control unit 100. In various embodiments, the control circuit 110 may hardware, a processor executing firmware instructions, a processor executing software instructions, or any combination thereof, configured to perform operations described herein.

The EEPROM 120a, 120b may store data. The data may include vehicle state information or vehicle failure information.

The control unit 100 may include a plurality of EEPROMs 120a, 120b. For example, the control unit 100 may include a first EEPROM 120a and a second EEPROM 120b.

The RAM 130 may store encrypted data that encrypts a value corresponding to data stored in the EEPROM 120a, 120b with a roll-back key. The control circuit 110 may decrypt the encrypted data with the roll-back key to generate decrypted data, and may roll back the data using the decrypted data.

The RAM 130 may be a standby RAM. The standby RAM may maintain data as long as power is not completely cut off. The standby RAM may be specifically designed to retain data even when switched to low power mode. The standby RAM may be non-volatile RAM (NVRAM) or ferroelectric RAM (FRAM).

In an embodiment in which the RAM 130 is the standby RAM, the control unit may further include a static RAM (SRAM). When the power supply to the control circuit 110 is cut off, the SRAM may volatilize all stored values. In contrast, the standby RAM may maintain stored data, for example, encrypted data described below, even when the power supply to the control circuit 110 is cut off, and in this connection, a small amount of power may be supplied to the standby RAM.

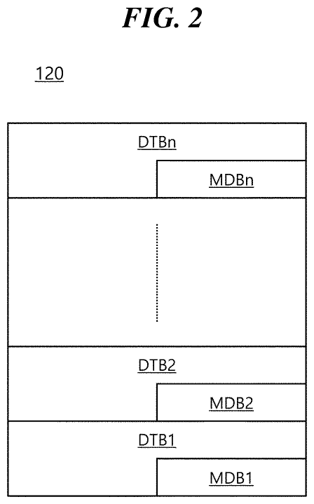

FIG. 2 is a block configuration diagram illustrating an EEPROM according to an embodiment.

Referring to FIG. 2, an EEPROM 120 (e.g., corresponding to the EEPROM 120a, 120b of FIG. 1) may include a plurality of blocks (DTB1 to DTBn, MDB1 to MDBn). In addition, respective blocks (DTB1 to DTBn, MDB1 to MDBn) may be divided into a data area (DTB1 to DTBn) and a metadata area (MDB1 to MDBn).

The EEPROM 120 may be divided into several blocks (DTB1 to DTBn, MDB1 to MDBn), and each block may include several pages and cells. In an embodiment, the block may be used as a unit to manage a memory and efficiently store data.

The EEPROM 120 may write data in byte units, but may be erased in block units. An entire block may be erased at a time. Block-unit erasing may help extend the life of memory cells and maintain data integrity. In addition, the block structure may be important for managing limited write/erase cycles in the EEPROM 120.

In the EEPROM 120, data may be stored in the data area (DTB1 to DTBn). In addition, the roll-back key may be stored in the metadata area (MDB1 to MDBn).

The data area (DTB1 to DTBn) may include N blocks (N is a natural number), and the metadata area (MDB1 to MDBn) may include N blocks. The number of blocks of data blocks (DTB1 to DTBn) and the number of blocks of metadata blocks (MDB1 to MDBn) may be the same.

The data blocks (DTB1 to DTBn) and the metadata blocks (MDB1 to MDBn) may be matched one-to-one. For example, a first data block (DTB1) may be matched with a first metadata block (MDB1), and a second data block (DTB2) may be matched with a second metadata block (MDB2).

The data blocks (DTB1 to DTBn) and the metadata blocks (MDB1 to MDBn) may be in order. In addition, the data blocks (DTB1 to DTBn) and the metadata blocks (MDB1 to MDBn) may be recorded in this order. For example, after data is recorded in the first data block (DTB1), the second data block (DTB2) may be recorded. In addition, after data is recorded in the second data block (DTB2), the third data block (DTB3) may be recorded. Also in the metadata block, after data is recorded in the first metadata block (MDB1), the second metadata block (MDB2) may be recorded. In addition, after data is recorded in the second metadata block (MDB2), the third metadata block (MDB3) may be recorded.

New data may be sequentially stored in a block in which data is not stored among the data blocks (DTB1 to DTBn), whereas when data is stored in all blocks, data may be sequentially reused in order from a block in which data was first stored among the plurality of blocks.

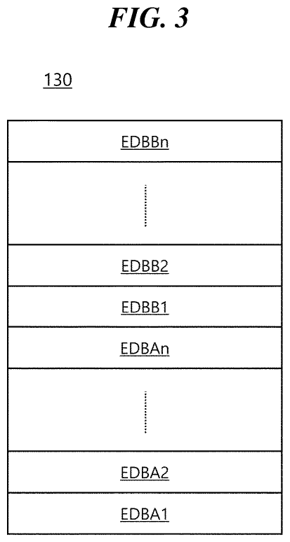

FIG. 3 is a block configuration diagram illustrating a RAM according to an embodiment.

Referring to FIG. 3, the RAM 130 may include a plurality of blocks (EDBA1 to EDBAn, EDBB1 to EDBBn).

In addition, each block (EDBA1 to EDBAn, EDBB1 to EDBBn) may be divided into an area corresponding to the plurality of EEPROMs. For example, a first RAM data area (EDBA1 to EDBAn) may correspond to a first EEPROM (e.g., EEPROM 120a in FIG. 1), and a second RAM data area (EDBB1 to EDBBn) may correspond to a second EEPROM (e.g., EEPROM 120b in FIG. 1).

A plurality of encrypted data blocks may be disposed in each area. For example, the plurality of encrypted data blocks (EDBA1 to EDBAn) corresponding to the first EEPROM may be disposed in the first RAM data area, and the plurality of encrypted data blocks (EDBB1 to EDBBn) corresponding to the second EEPROM may be disposed in the second RAM data area.

Each encrypted data block may be matched one-to-one with each data block of each EEPROM. For example, a first encrypted data block (EDBA1) corresponding to the first EEPROM may be matched to a first data block of the first EEPROM, a second encrypted data block (EDBA2) corresponding to the first EEPROM may be matched to a second data block of the first EEPROM, and a third encrypted data block (EDBA3) corresponding to the first EEPROM may be matched to a third data block of the first EEPROM.

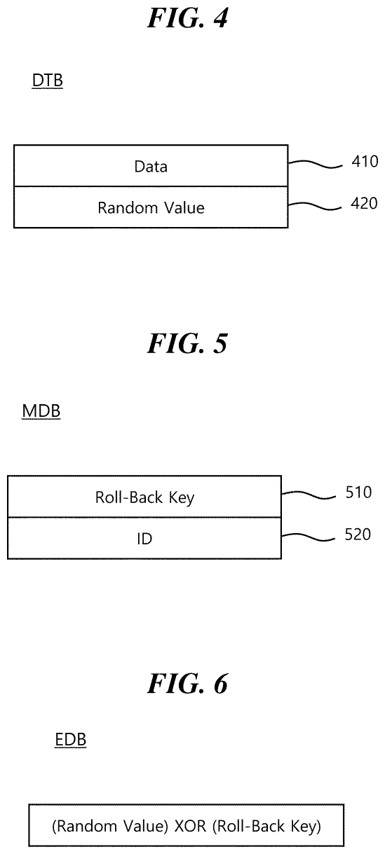

FIG. 4 is a part configuration diagram illustrating a data block according to an embodiment.

Referring to FIG. 4, the data block (DTB) may include a data part 410 and a random value part 420.

Data may be stored in the data part 410. For example, vehicle state information or vehicle failure information may be stored in the data portion 410.

A random value may be stored in the random value part 420. The random value part 420 may have a size of 4 bytes. In an embodiment, a random value of 4 bytes may be stored in the random value part 420.

The random value may be generated by the control circuit. When data is stored in the data part 410, the control circuit may generate the random value and store the generated random value in the random value part 420. For example, the control circuit may generate a random value from a seed value using a mathematical algorithm. In an embodiment, the seed value may be a time value. As another example, the control circuit may generate a random value using a sensing value for noise acquired from hardware.

FIG. 5 is a part configuration diagram illustrating a metadata block according to an embodiment.

Referring to FIG. 5, the metadata block (MDB) may include a roll-back key part 510 and an identifier part 520.

The roll-back key for encrypting a value corresponding to data stored in the data part may be stored in the roll-back key part 510.

In addition, an identifier for identifying a block and/or metadata area may be stored in the identifier part 520.

FIG. 6 is a part configuration diagram illustrating an encrypted data block according to an embodiment.

Referring to FIG. 6, the encrypted data block (EDB) may include one part.

In an embodiment, the encrypted data block (EDB) may store encrypted data that is a value corresponding to data stored in the data block and encrypted using the roll-back key.

The value corresponding to the data stored in the data block may be, for example, a random value stored in the corresponding data block. The encrypted data block (EDB) may store such random value after being encrypted by the roll-back key.

Depending on an embodiment, the encrypted data block (EDB) may store the entire data and random value stored in the data block by encrypting the same with the roll-back key. Hereinafter, for convenience of explanation, it is described that the encrypted data block (EDB) stores data encrypted by the roll-back key with the random value.

The random value may be XOR-operated with the roll-back key to become encrypted data. The control circuit may generate encrypted data by performing an XOR operation on the random value with the roll-back key.

The XOR (eXclusive OR) operation is a logical operation between two bits, which returns 1 when the two bits are different, and 0 when the two bits are the same. When there are two input bits A and B, the XOR operation becomes 1 when A and B are different, and 0 when A and B are the same. When XOR is used in encryption, XOR may also be used in decryption.

The control circuit may generate decrypted data by performing an XOR operation on encrypted data with the roll-back key.

The control unit may include the plurality of EEPROMs, and encrypted data may be stored separately for each EEPROM in the RAM.

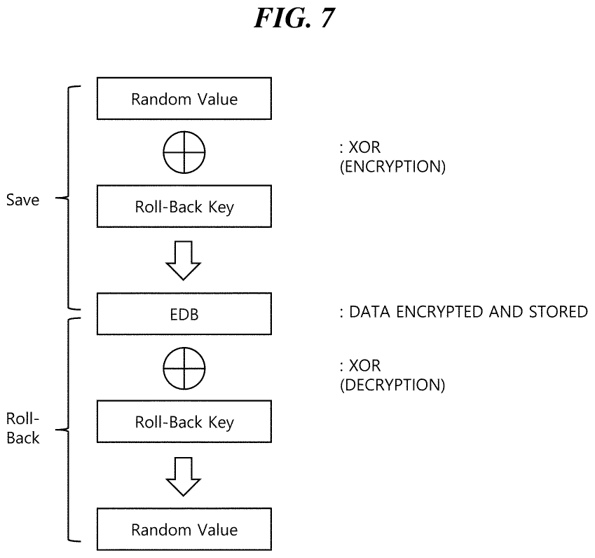

FIG. 7 is a diagram illustrating a process of a control unit encrypting and decrypting a random value according to an embodiment.

Referring to FIG. 7, the control unit may encrypt the random value using the roll-back key. The control unit may store encrypted data generated through encryption in the standby RAM.

The encryption may be performed through the XOR operation. The control unit may generate the encrypted data by performing the XOR operation on the random value and the roll-back key. The control unit may store the encrypted data in the encrypted data block (EDB) of the standby RAM.

Then, when rolling back, the control unit may decrypt the encrypted data stored in the encrypted data block (EDB) to check the random value. The control unit may find a data block where the checked random value is stored, check data matched with the random value and stored in the data block, and roll back the same.

The control unit may decrypt encrypted data using the roll-back key. The control unit may generate decrypted data by performing an XOR operation on the encrypted data and the roll-back key. The decrypted data may be the same value as the random value described above.

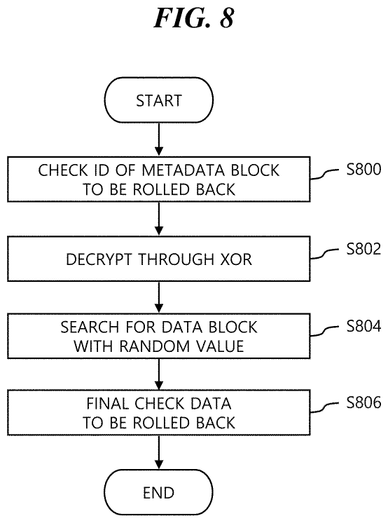

FIG. 8 is a diagram illustrating a process of a control unit rolling back data according to an embodiment.

Referring to FIG. 8, in an operation S800, the identifier of the metadata block to be rolled back may be checked. Data may be sequentially stored in each block, and the order in this connection may be determined by the identifier of the metadata block. The control unit may use this identifier when finding a data block to be rolled back. The control unit may check the roll-back key in the metadata block in which the identifier is stored.

In an operation S802, the control unit may check the encrypted data block matching the metadata block whose identifier is checked, and may decrypt the encrypted data stored in the encrypted data block using the roll-back key checked in the metadata block. For example, the control unit may decrypt the encrypted data using the XOR operation.

In an operation S804, after checking the random value through decryption of the encrypted data, the control unit may search for a matching data block by comparing the random values stored in the data blocks with the decrypted random value.

In an operation S806, the control unit may check the data block in which the same random value as the decrypted random value is stored, and read data from the data block to complete the rollback of the EEPROM data.

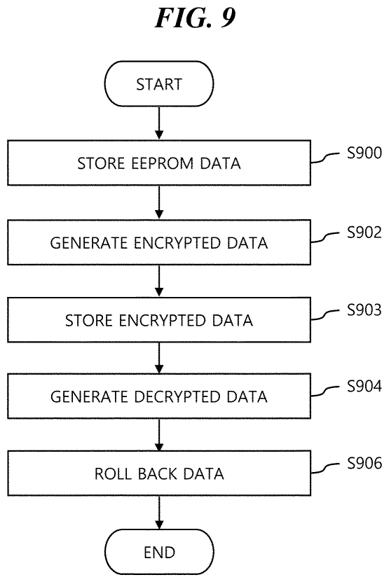

FIG. 9 is a flowchart of a control method in which a control unit supports rollback of EEPROM data according to an embodiment.

Referring to FIG. 9, in an operation S900, the control unit may store data in at least one of the EEPROMs.

In an operation S902, the control unit may generate encrypted data by encrypting a value corresponding to data with the roll-back key. In an operation S903, the control unit may store the encrypted data in the standby RAM.

The EEPROM may include the plurality of blocks, and each block may be divided into the data area and the metadata area. In an embodiment, when the control unit stores data generated in the operation S902 in the EEPROM, the data may be stored in the data area. In addition, in connection with generating encrypted data in the operation S902, the control unit may generate encrypted data using the roll-back key stored in the metadata area. An identifier for identifying the aforementioned block or metadata area may be further stored in the metadata area.

In an operation S904, the control unit may decrypt the encrypted data with the roll-back key to generate decrypted data.

Each EEPROM may have a plurality of roll-back keys stored for each block. When the control unit generates decrypted data in the operation S904, the control unit may finalize the roll-back key for decryption according to the identifier described above.

In an operation S906, the control unit may roll back data stored in the EEPROM using the decrypted data.

When the control unit stores data in the EEPROM in the operation S900, the random value may be further stored in the data area. In an embodiment, when the control unit generates encrypted data in the operation S902, the control unit may generate encrypted data by encrypting the random value with the roll-back key. In an embodiment, when the control unit rolls back data in the operation S906, the control unit may compare the decrypted data with the random values stored in the plurality of blocks to find a block matching the decrypted data, and determine the data of the corresponding block as the data to be rolled back.

In an embodiment, when the control unit generates encrypted data in the operation S902, the control unit may generate encrypted data by performing an XOR operation on the value corresponding to the data stored in the EEPROM with the roll-back key.

In an embodiment, when the control unit generates decrypted data in the operation S904, the control unit may generate the decrypted data by performing an XOR operation on the encrypted data with the roll-back key.

Data stored in the EEPROM may include vehicle state information or vehicle failure information.

The control unit may store temporary data in the SRAM. In an embodiment, when the power supply to a device controlling the EEPROM is cut off, all values stored in the SRM may be volatile, but the standby RAM where the encrypted data is stored may maintain the encrypted data even while the power supply to the device controlling the EEPROM is cut off.

As described above, embodiments of the present disclosure may support the rollback of the EEPROM data and may replicate the EEPROM data.

The terms “comprises,” “comprising”, “includes,” “including”, “has”, “having”, or the like, used in the present disclosure should be interpreted to not exclude other elements but to further include such other elements since the corresponding elements may be inherent unless mentioned otherwise. All terms including technical or scientific terms have the same meanings as generally understood by a person having ordinary skill in the art to which the present disclosure pertains unless mentioned otherwise. Generally used terms, such as terms defined in a dictionary, should be interpreted as coinciding with meanings of the related art from the context. It should be understood that terms should not be interpreted in an idealized or overly formal sense unless expressly so defined herein.

Hereinbefore, although the technical ideas of the present disclosure have been disclosed for illustrative purposes, a person having ordinary skill in the art to which the present disclosure pertains should appreciate that various modifications and variations are possible, without departing from the spirit and essential characteristics of the present disclosure. Therefore, the embodiments of the present disclosure are described only for illustrative purposes and should not be construed as limiting the technical ideas of the present disclosure. The scope of protection of the present disclosure should be determined on the basis of the descriptions in the appended claims, and all technical ideas within the scope of equivalents thereof should be construed as being included in the scope of right of the present disclosure.

What is claimed is:

1. A control unit comprising:
at least one electrically erasable programmable read-only memory (EEPROM) configured to store data;
a standby random access memory (RAM) configured to store encrypted data that encrypts a value corresponding to the data with a roll-back key; and
a control circuit configured to decrypt the encrypted data with the roll-back key to generate decrypted data and roll back the data using the decrypted data.

2. The control unit of claim 1, wherein:
the EEPROM includes a plurality of blocks, wherein each block is divided into a data area and a metadata area; and
the control circuit is configured to store the data in the data area and store the roll-back key in the metadata area.

3. The control unit of claim 2, wherein the metadata area of a block includes an identifier stored for identifying the block or the metadata area.

4. The control unit of claim 2, wherein the control circuit is further configured to:
store a random value in the data area;
encrypt the random value to generate an encrypted random value; and
store the encrypted random value in the standby RAM.

5. The control unit of claim 1, wherein the control circuit is configured to perform an XOR operation between the value corresponding to the data is XOR-operated and the roll-back key to generate the encrypted data.

6. The control unit of claim 5, wherein the control circuit is configured to perform an XOR operation between the encrypted data and the roll-back key to generate the decrypted data.

7. The control unit of claim 1, wherein:
the control unit comprises a plurality of EEPROMs; and
the control circuit is configured to store the encrypted data separately for each EEPROM in the standby RAM.

8. The control unit of claim 1, wherein the data includes vehicle state information or vehicle failure information.

9. The control unit of claim 1, wherein:
the control unit further comprises a static RAM (SRAM) in which stored values are volatile when power supply to the control circuit is cut off; and
the standby RAM is configured to maintain the encrypted data while the power supply to the control circuit is cut off.

10. The control unit of claim 2, wherein the control circuit is configured to:
store new data sequentially in a block in which data is not stored among the plurality of blocks; and
when data is stored in all blocks, sequentially reuse the blocks in order from a block in which data was first stored among the plurality of blocks.

11. A control method for supporting rollback of EEPROM data, the method comprising:
storing data in at least one electrically erasable programmable read-only memory (EEPROM);
encrypting a value corresponding to the data with a roll-back key to generate encrypted data;
storing the encrypted data in a standby random access memory (RAM);
decrypting the encrypted data with the roll-back key to generate decrypted data; and
rolling back the data using the decrypted data.

12. The method of claim 11, wherein:
the EEPROM includes a plurality of blocks, wherein each block is divided into a data area and a metadata area;
storing the data in the EEPROM includes storing the data in the data area; and
generating the encrypted data includes generating the encrypted data using the roll-back key stored in the metadata area.

13. The method of claim 12, wherein the metadata area of a block includes an identifier stored for identifying the block or the metadata area.

14. The method of claim 13, wherein:
the EEPROM includes a plurality of roll-back keys stored for each block; and
the control method further comprises finalizing the roll-back key for decryption according to the identifier before generating the decrypted data.

15. The method of claim 12, wherein:
storing the data in the EEPROM further includes storing a random value in the data area; and
generating the encrypted data includes encrypting the random value with the roll-back key.

16. The method of claim 15, wherein rolling back the data includes:
comparing the decrypted data with random values stored in the plurality of blocks to find a matching block that matches the decrypted data, and
determining the data of the matching block as the data to be rolled back.

17. The method of claim 11, wherein generating the encrypted data includes generating the encrypted data by performing an XOR operation on the value corresponding to the data with the roll-back key.

18. The method of claim 17, wherein generating the decrypted data includes generating the decrypted data by performing an XOR operation on the encrypted data with the roll-back key.

19. The method of claim 11, wherein the data comprises vehicle state information or vehicle failure information.

20. The method of claim 11, further comprising storing temporary data in a static RAM (SRAM), wherein:
values stored in the SRAM is volatile when power supply to a device controlling the EEPROM is cut off; and
the standby RAM is configured to maintain the encrypted data while the power supply to the device controlling the EEPROM is cut off.
